(19) United States
(12) Patent Application Publication
(10) Pub. No.: US 2014/0102489 A1
(43) Pub. Date: Apr. 17, 2014

(54) TRUCK AND WHEEL WASH APPARATUS

(71) Applicant: HOLT TEXAS LTD. d/b/a HOLT CAT, (US)

(72) Inventor: Steven Smith, San Antonio, TX (US)

(21) Appl. No.: 13/785,427

(22) Filed: Mar. 5, 2013

Related U.S. Application Data
(60) Provisional application No. 61/712,431, filed on Oct. 11, 2012.

(51) Int. Cl. B60S 3/04

(52) U.S. Cl. CPC B60S 3/042
USPC 134/123

(57) ABSTRACT

A truck wash apparatus comprising a frame comprising at least some fluid bearing members adapted to support a truck above a support surface, the fluid bearing members including a left and right pair of longitudinal members and multiple cross-members, the frame members defining the walls configured to carry a wash fluid, and to also support a truck above a support surface. A multiplicity of tire engaging tire support members may be included in the frame and adapted to engage the inner walls of each of the left and right pairs of longitudinal members. A left side rail and a right side rail in fluid communication with the frame are provided for location outside of and above the left and right pair of spaced apart longitudinal members. The side rails are adapted to carry wash fluid. A multiplicity of nozzle assemblies, each having a body and a head, the body with walls adapted to engage the frame and to engage the head is provided.

This application claims priority to and the benefit of U.S. Provisional Patent Application Ser. No. 61/712,431, filed Oct. 11, 2012, the contents of which are incorporated herein by reference.

### FIELD OF THE INVENTION

Vehicle washing apparatus, more specifically, a truck wash apparatus.

### BACKGROUND OF THE INVENTION

Over the years, a number of car wash spraying apparatuses have evolved to provide effective cleaning of a vehicle. For example, self-serve vehicle washes typically have a drive-in bay, machine fed device, a flexible, handheld wash wand, and a fluid selection dial. The user, with a handheld wand, will go around the car and select the wash cycle as he washes the car.

Other vehicle wash devices have drive-thru bays which may include moving gantries with multiple spray nozzles and brushes.

Often, on large vehicles or construction trucks, the main area of concern is the wheels and the undercarriage, where dust can collect—especially, for example, when the trucks are used at construction operations where there are dirt roads. While some of the prior art systems have been used for washing these areas, many use high volumes of water with low water pressure. These, in some situations, may prove satisfactory, but have shortcomings in other areas. Oftimes, these truck/wheel wash systems have rigid nozzles (fixed alignment) directed at the vehicle.

Therefore, there exists the need for a durable, reliable, simple, high performance, wheel washing and truck cleaning apparatus that is easy to manufacture, transport, install, use, and maintain.

### SUMMARY OF THE INVENTION

A truck wash apparatus comprising a frame comprising at least some fluid bearing members adapted to support a truck above a support surface, the fluid bearing members including a left and right pair of longitudinal members and multiple cross-members, the frame members defining the walls configured to carry a wash fluid, and to also support a truck above a support surface. A multiplicity of tire engaging tire support members may be included in the frame and adapted to engage the inner walls of each of the left and right pairs of longitudinal members. A left side rail and a right side rail in fluid communication with the frame are provided for location outside of and above the left and right pair of spaced apart longitudinal members. The side rails are adapted to carry wash fluid. A multiplicity of nozzle assemblies, each having a body and a head, the body with walls adapted to engage the frame and to engage the head is provided. The body typically includes a ball and socket assembly for directing the head in a multitude of directions. The multiplicity of nozzle assemblies may include at least a first group having a head configured to provide a flat, fan spray pattern of between about 50 and 110° (in one embodiment; 5° to 110° in another embodiment). A second group having a uniform stream spray pattern may be provided. Other heads may have other suitable spray patterns. The frame and raised side rails are adapted to receive the multiplicity of nozzle assemblies thereon. A pump assembly is adapted to engage a source of wash fluid, for providing about 50 to 60 psi (or more broadly about 40-80 psi), to the nozzle assemblies, generating a flow rate of between about 800 and 1600 gpm (or more broadly about 200 to 3000 gpm).

### BRIEF DESCRIPTION OF THE DRAWINGS

FIG. 1 is a perspective view of Applicant's truck wash system.

FIG. 2 is a top plan view of the system.

FIG. 3 is a side elevational view of the right side of the system, with the right and left sides being the same, and showing the truck wash system in one environment, including a concrete structure.

FIG. 4 is a side elevational partial view of longitudinal and transverse elements of the frame showing the manner in which the spray nozzle assemblies are mounted to the frame elements and the spray pattern generated therefrom.

FIG. 5 is an end view showing the position of the spray nozzle assemblies on the frame and side rail members and the spray pattern generated therefrom.

FIG. 6 is a detail view of the indicated section of FIG. 5 in cross-section showing a spray head of a spray assembly having a 15° spray fan nozzle.

FIG. 7A is a cutaway side view of a spray nozzle assembly.

FIGS. 7B, 7C, and 7D illustrate various nozzle heads for engagement to a body of the spray nozzle assembly as indicated in FIG. 7A.

### DETAILED DESCRIPTION OF THE PREFERRED EMBODIMENTS

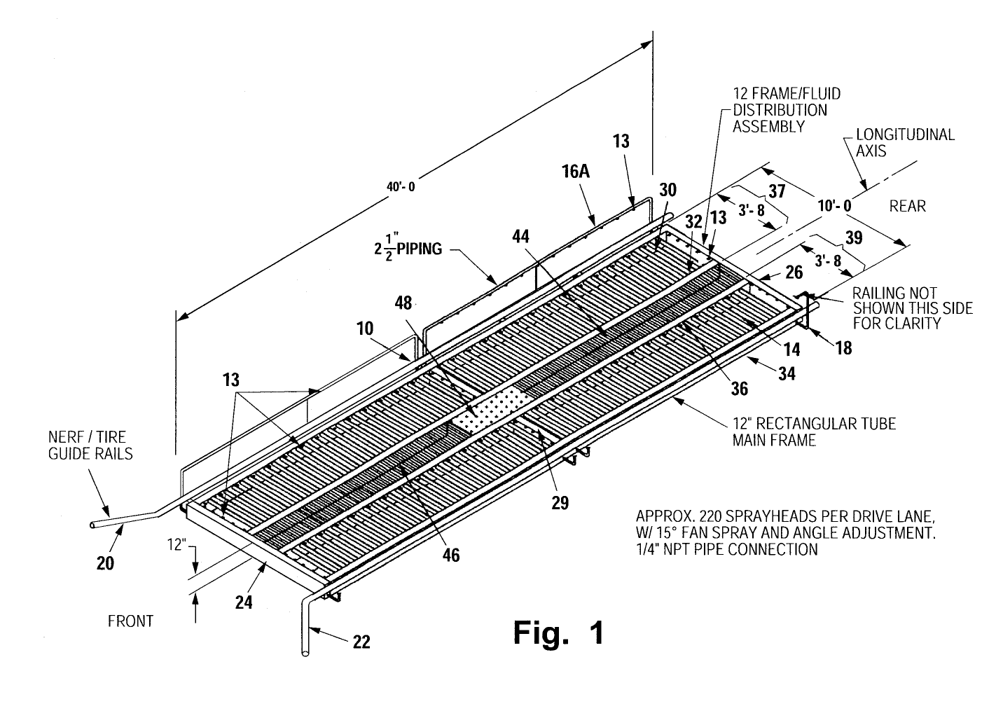

FIGS. 1-6 illustrate details of applicant's truck wash assembly 10. Applicant's truck wash assembly 10 is seen to comprise a combined frame and fluid distribution assembly 12. Frame and fluid distribution assembly 12 has a multiplicity of members welded together, which are hollow and contain a multiplicity of spray nozzle assemblies 13 engaged therewith. Frame and fluid distribution assembly 12 serves to both support the weight of the vehicle on a truck wash apparatus through engagement with a multiplicity of non-fluid-bearing tire support members 14, but also serves to distribute fluid from one or more pumps 42 through fluid inlets 38/40 engaging the interior of the frame and fluid distribution assembly 12.

Frame and fluid distribution assembly 12 includes a left-side pair of left outer/left inner longitudinal members 30/32 and a pair of right outer/right inner longitudinal members 34/36, each member of the pair spaced apart from one another about 3 feet 8 inches and the pairs separated from one another by about 2 feet 8 inches (see FIG. 1) or any other suitable distance. There may be a fluid bearing center cross-member 28 between the inner walls of longitudinal members 30/32 and a fluid bearing center cross-member 29 between the inner walls of longitudinal members 34/36 as seen in FIG. 1. The two pairs define left and right side vehicle tire tracks 37/39 that lie adjacent longitudinal axis LA running longitudinally down the center of truck wash assembly 10.

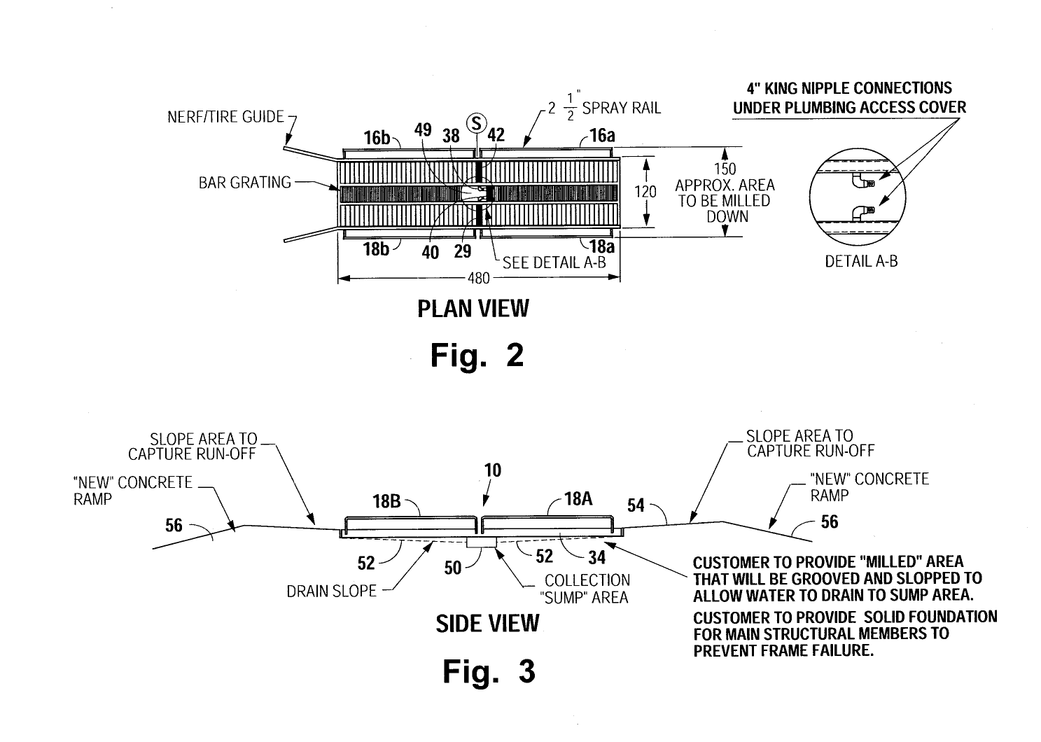

The left and right side tire tracks 37/39 are spaced apart and fluidly communicate with one another through the use of front end cross-member 24 and rear end cross-member 26. Thus, it can be seen that frame members 24/26/28/29/30/32/34/36 are in fluid communication with one another and with fluid inlets 38/40 for receiving a wash fluid through one or more pumps 42. Pumps 42 may be connected to a source S of wash fluid (see FIG. 2). Further, a pair of lateral rails 16/18 (left and right side) are provided, which may include multiple longitudinal members 16a/16b/18a/18b typically spaced laterally outward from and above and parallel to frame members 30/34.

Lateral side rails 16/18 are in fluid communication with frame and fluid distribution assembly 12 as seen in FIG. 2, wherein each of the lateral side rails may include a pair of longitudinal members 16a/16b/18a/18b, which also have downwardly depending and inwardly depending members which are fluidly coupled to elements of the frame and fluid distribution assembly 12 (such as outer members 30/34) as best seen in FIG. 2, for example.

Turning to FIG. 6, it is seen that members of the frame and fluid distribution assembly 12 have an inner cavity 12a that connects all the fluid bearing elements thereof, as well as fluidly connects the frame and fluid distribution assembly 12 to the lateral side rails 16/18. That cross-sectional view reveals a rectangular cross-section, including vertical walls (although any suitable configuration of frame members is anticipated). In FIG. 6, moreover, it is seen that a multiplicity of spray nozzle assemblies 13 are mounted to the fluid bearing elements of frame and fluid distribution assembly 12 at one or more points as set forth hereinbelow through the use of a fluid tight, drilled machine mounting stud or block 15 (typically threaded), which may be welded to the side walls (or other suitable location) of the frame and fluid distribution assembly 12. Turning to FIG. 5, it is seen in one embodiment that spray nozzle assemblies 13 may be mounted and inwardly directed towards LA along lateral side rail sections 16a/16b/18a/18b.

There is further structure, in addition to the fluid carrying elements, that is, frame and fluid distribution assembly 12 and lateral side rails 16/18 with a multiplicity of jets attached thereto. As more specifically arranged below, Applicant's novel truck wash assembly may include two bar grate cover assemblies 44/46, a plumbing access cover plate 48, and a pair of left and right side bumpers 20/22.

Bar grate cover assemblies 44/46 may be made of longitudinal steel bar elements running transverse between the tire tracks 37/39 as seen in FIG. 1. Plumbing access cover plate 48 may be tabular in nature and is adapted to cover and protect a pump and other equipment located in bay 49, which is typically located adjacent cross-members 28/29 and may provide space for pump elements or for pump inlets 38/40. Side bumpers 20/22 are sturdy metal elongated rails engaged by struts to be placed above and slightly outside of outer members 30/34 of frame and fluid distribution assembly 12 as seen in FIG. 1. Side bumpers 20/22 are configured and located so as to contact the body or tires of a vehicle driving or moving down the longitudinal axis LA if it were to inadvertently turn one way or the other rather than following a straight path with its tires in tracks 37/39. Side bumpers 20/22 are not typically fluid bearing members and are sturdy enough to maintain, under normal conditions, a vehicle on the tread tracks.

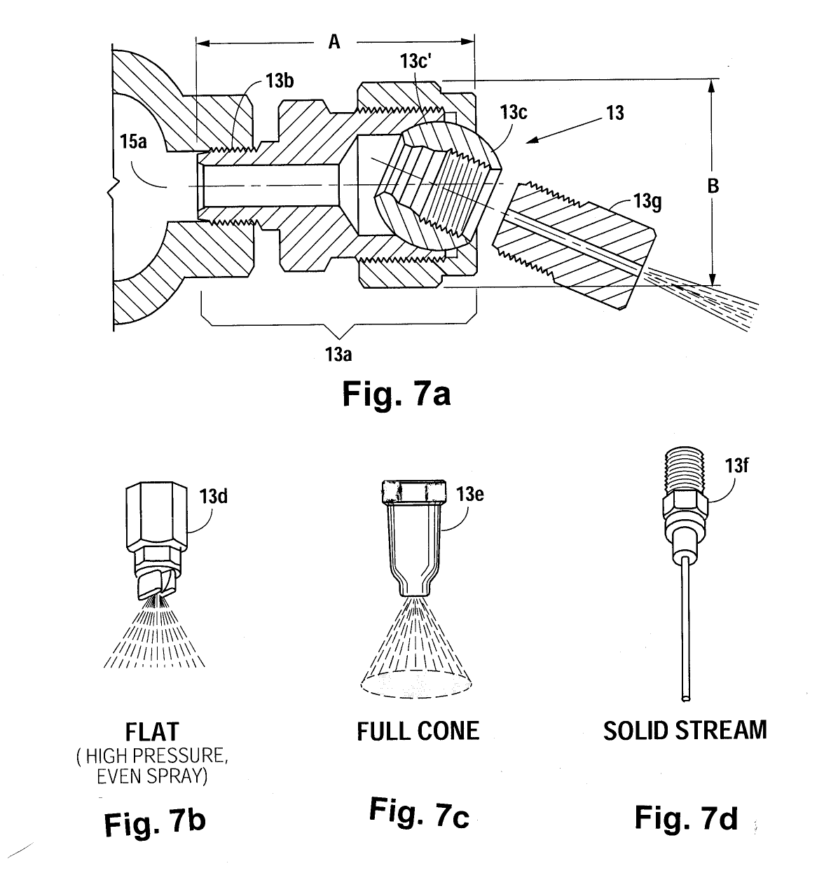

Turning now to FIGS. 7A-7E, details of the spray nozzle assemblies 13 may be seen. With reference to FIG. 7A, spray nozzle assembly 13 is seen to include a body 13a, which may include in a preferred embodiment, a ball-in-socket combination. Body 13a typically includes male threaded portion 13b for engagement to drilled through and tapped mounting block 15 (see drilled out channel 15a) in fluid sealing communication. Body 13a may typically include female threaded elements or portion typically on a ball 13c of a ball-in-socket arrangement as seen in FIG. 7A, to give selected rotational and angular direction (in one embodiment, about 22.5° sweep from straight, 45° included angle) to head 13g threadably or otherwise fluidly engaged therewith.

High pressure water in a socket 13c′ received at body 13a will be transmitted through the body to the head, which may be set at one or more angular configurations for directing the head in a general direction. Indeed, not only are ball-in-socket elements of body 13a provided to give direction to head 13g, but heads 13g of a group of mounted assemblies typically comprise two or more of the jet selections set forth in FIGS. 7A, 7B, and 7C.

FIG. 7B illustrates a head 13d, such as a Spraying Systems Company Veejet® Model H14U450, which will generate a flat spray fan in one embodiment at an angle of 40° or any spray angle between about 5 and 110 degrees (about 55-100° preferred). FIG. 7C illustrates a head 13e that will provide a conical fan water pattern, such as a Spraying Systems Company Model H14U1550. FIG. 7D illustrates a head 13f comprising a solid stream of fluid (non-diverging), such as that generated by a Spraying Systems Company Model H14U0050. These jets may be found at page 4 of the Spraying Systems Company catalog as found at the Spraying Systems website: www.spray.com.

The various heads are seen to have threaded elements that may engage the body, typically the ball members 13c of body 13a, typically through fluid tight threaded elements. The various heads may include male threaded elements for receipt into the female threaded elements of body 13a as seen in FIG. 7A or there may be a male/male coupling member (not shown) to engage female threaded elements on the head with female threaded elements of the ball 13c of body 13a.

The pump or pumps 42 that provide a wash fluid to the frame and fluid distribution assembly 12 and side rails, and the jets are adapted to provide a pressure of about 18 psi to 80 psi in one range, more preferred 40-80 psi, and most preferred 50-60 psi at the jets and are designed to provide, typically about 1000 gpm wash fluid flow rate (range 200 to 3000 gpm, more preferred 800-2000 gpm). Moreover, there may be typically about 220 jets (range about 50 to 500) located on the fluid bearing elements of Applicant's truck wash as set forth in more detail below.

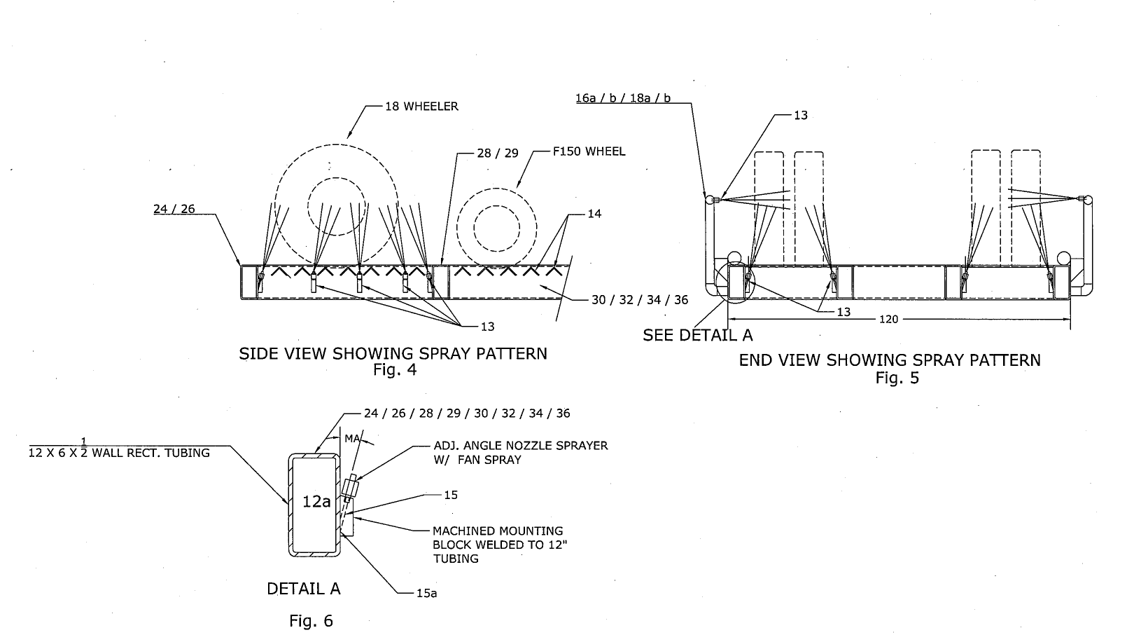

Turning now to FIG. 6, it is seen that some of the multiplicity of spray jets are mounted to vertically disposed inner wall members of the frame and fluid distribution assembly 12, including the inner walls of the longitudinal members and the inner walls of the front and rear cross-members. Moreover, with reference to FIG. 6, there may be seen to be a mounting angle MA defined by the axis, more particularly, the axis of threaded elements 13b of body 13a, which mounting axis a is upward and oblique with respect to the vertical side walls inner members as seen in FIG. 6. Angle α is typically about 15 degrees and may be in the range of about 5 to 30 degrees. There may also be a multiplicity of jets mounted at the same angle to mounting blocks 15 on the opposed vertical walls of the center cross-members 28/29, again typically at mounting angle α. In one preferred arrangement, a group of nozzles are spaced along the inner walls of frame and fluid distribution assembly elements 30/32/34/36 and spaced between the transversely mounted tire support members 14 as seen in FIGS. 1 and 4.

Turning to FIGS. 1 and 5, it is seen that a multiplicity of spray nozzle assemblies 13 are mounted to horizontal lateral longitudinal members 16a/16b/18a/18b at a mounting angle of about 90° using as reference a plane parallel to the inner walls of the longitudinal members 30/32/34/36 that is tangent to the outer surface of the longitudinal members at the mounting point of the jets to the longitudinal members. The heads may include both stream and fan (flat or cone) patterns, with typically those heads generating stream being directed inward about 15° (or other suitable angle) on both ends of the lateral members and all of the stream bearing jets directed downward about 15°-30°.

Turning now to FIG. 3, a sump 50 may be provided with a drain slope 52 to either side thereof which may be concrete so as to support truck wash apparatus 10 from either end (or the sides) of frame and fluid distribution assembly 12. Moreover, sump 50 and adjacent drain slopes 52 may be comprised of concrete and they may be integral with a sloped section 54 on either side of truck wash assembly 10, which sloped sections 54 will drain wash fluid and other spray down into the sump to capture runoff. Finally, concrete ramps 56 may provide drive up for raising the vehicle for rundown on slope area 54 to the truck wash apparatus 10.

Spray nozzle assemblies 13 may be broken down, in one embodiment, into two categories by virtue of their location and direction of mounting: first group A, upwardly directed (from below the truck); and second group B, laterally inwardly directed (stream heads directed downward, upward or sideways), those being nozzle assembles mounted on the side rails. The first group A are adapted directionally to focus generally on the wheels and undercarriage as the vehicle rolls through the truck wash assembly, and the second group B about axle height directed inward toward the tire rims. Typically, group A will have the effect of spraying the undercarriage also when the wheels are not located in an interference position. With the use of some fan or cone shaped heads (or a mix of the two) on the inner walls of the longitudinal members and walls of the cross-members of a subset of first group, Group A1, will create a fan spray that will extend, typically when the fan is in the angular range of 5° to 115°, across the underside of the undercarriage of the vehicle to substantially coat the same. Some jets in Group A1, for example, may be mounted transverse to the longitudinal axis as on the side walls of the cross-member.

It is seen that the members of the frame and fluid distribution assembly lay in a generally horizontal plane (excluding the raised side rails). Moreover, most of the elements of the truck, except a small portion of the contact patch of the tires, lies above the fluid bearing members of the frame. The truck passes down a longitudinal axis LA of the frame with wheels in each of the two tire paths which are typically about 3′8″ apart (see FIG. 1) with the outer members of each pair 30/34 being about 10 feet apart in one embodiment. It is also seen with reference to FIG. 1 that a truck moving in the arrows indicated from front to rear may be subject to a number of upwardly-directed (with respect to the horizontal plane) nozzles where the axis of the nozzle body is directed upward. However, the Group A nozzle assemblies may have other specific orientations included within the upward direction. These include upward and front directed nozzles, for example, along the front inner side walls of rear cross member 26 and center cross members 28/29. Group A nozzles may also be upward and rearwardly directed, for example, at some of those mounted on the inner side walls of front cross member 22 and the rearward-facing walls of center cross members 28/29. Moreover, it is seen that the outwardly-facing walls of inner-longitudinal members 32/36 may have the nozzle assemblies mounted such that the longitudinal axis of the bodies are directed upward but outward with respect to longitudinal axis LA.

Applicant provides easily-replaceable heads 13g that may be provided in a number of head configurations—flat spray, cone spray, jet stream or other suitable pattern. These may be changed out by the user as necessary (they are threaded) and their direction vis a vis the axis of body 13a of the nozzle assembly may be adjusted by virtue of the ball and socket combination.

The jets and pump system frame and fluid distribution assembly 12 and rails are adapted to provide high pressure, low flow rates so as to conserve wash fluid. That is to say, the pressure and flow rate specifications are found to provide sufficient water volume and sufficient droplet or water velocity and energy to utilize the water velocity for dislodging and cleaning, rather than water mass that is provided by some “flood-type” vehicle wash assemblies.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A truck wash apparatus comprising:
a frame comprising a multiplicity of fluid bearing members, the fluid bearing members including a left and right pair of longitudinal members and multiple cross-members, the frame members defining the walls configured to carry a wash fluid, and to also support a truck above a support surface, the frame including a multiplicity of tire engaging tire support members adapted to transversely engage the inner walls of each of the left and right pairs of longitudinal members;
a raised left side rail and raised right side rail, in fluid communication with the frame, for location outside of and above the left and right pair of spaced apart longitudinal members, the side rails adapted to carry fluid therein;
a multiplicity of nozzle assemblies, each nozzle assembly having a body and a removable head, the body with walls adapted to engage the frame at a fixed axis and to engage the head, the body including a ball and socket assembly for directing the head in a multitude of directions with regard to the fixed axis of the body; and
wherein the frame and raised side walls are adapted to receive the multiplicity of nozzle assemblies thereon.

2. The truck wash apparatus of claim 1, wherein the multiplicity of nozzle assemblies include at least a first nozzle group having a head providing a flat, fan spray pattern of between about 5 and 110° and a second nozzle group having a head providing a uniform stream spray pattern, the heads of the groups adapted to have engagement configuration common to one another.

3. The truck wash apparatus of claim 1, further including a pump assembly adapted to engage a source of wash fluid and at least some of the fluid-bearing frame members and the raised side rails, for providing about 50 to 60 psi, to the nozzle assemblies, such that a flow rate of between about 800 and 1600 gpm is provided.

4. The truck wash apparatus of claim 1, wherein the frame includes non-fluid bearing members.

5. The truck wash apparatus of claim 2, wherein the support surface is a horizontal plane with a longitudinal and transverse axis as well as a vertical axis perpendicular to the horizontal plane.

6. The truck wash apparatus of claim 5, wherein each of the pairs of the longitudinal members includes an outer and an inner member and wherein the nozzle assemblies include a third group, the third group engaging the inner walls of each member pair.

7. The truck wash apparatus of claim 6, further including a pump assembly adapted to engage a source of wash fluid and at least some of the fluid-bearing frame members and the raised side rails, for providing about 50 to 60 psi, to the nozzle assemblies, such that a flow rate of between about 800 and 1600 gpm is provided.

8. The truck wash apparatus of claim 7, wherein the frame includes non-fluid bearing members.

9. The truck wash apparatus of claim 1, wherein the support surface is a horizontal plane with a longitudinal and transverse axis as well as a vertical axis perpendicular to the horizontal plane; and wherein the multiplicity of nozzle assemblies include at least a first nozzle group having a head providing a flat, fan spray pattern of between about 5 and 110° and a second nozzle group having a head providing a uniform stream spray pattern; and wherein at least some of the nozzle assemblies of the first group are located on at least some of the inner walls of the longitudinal members.

10. The truck wash apparatus of claim 9, wherein the at least some of the nozzle assemblies of the first group engage the inner walls of the longitudinal members at an angle of between about 5° to about 30°.
